(19) United States
(12) Patent Application Publication
(10) Pub. No.: US 2025/0148734 A1
(43) Pub. Date: May 8, 2025

(54) SCENE CREATION USING LANGUAGE MODELS

(71) Applicant: Roblox Corporation, San Mateo, CA (US)

(72) Inventors: Behzad Haghgoo, Palo Alto, CA (US); Vinith Misra, San Mateo, CA (US); Maxwell Wen Xiong, San Jose, CA (US)

(73) Assignee: Roblox Corporation, San Mateo, CA (US)

(21) Appl. No.: 18/652,201

(22) Filed: May 1, 2024

Related U.S. Application Data
(60) Provisional application No. 63/596,729, filed on Nov. 7, 2023.

(51) Int. Cl. G06T 19/20; G06T 7/70

(52) U.S. Cl. CPC G06T 19/20; G06T 7/70; G06T 2219/2004; G06T 2219/2016; G06T 2219/2024

(57) ABSTRACT

A user prompt, such as a user prompt received by a client device and sent to an online game system, is provided into a trained large language model. The large language model identifies keywords corresponding to the user prompt. These keywords may be provided to a search engine that identifies corresponding object(s) to place in a virtual experience. The large language model further processes the user prompt to determine spatial placement information for the objects and places the objects accordingly. Subsequently, the system may iteratively receive more prompts and update the virtual experience based on the additional prompts. The placement may be facilitated using macros. The prompts may also affect other attributes of the objects. The knowledge built-into the LLM allows it to suggest which objects are relevant and what quantity and arrangements of these objects is consistent with a scene requested in the user prompt.

### CROSS-REFERENCE TO RELATED APPLICATIONS

This application claims priority to U.S. Provisional Application No. 63/596,729, entitled “SCENE CREATION USING LANGUAGE MODELS,” filed on Nov. 7, 2023, the content of which is incorporated herein in its entirety.

### TECHNICAL FIELD

Embodiments relate generally to computer-based gaming and virtual environments, and more particularly to methods, systems, and computer-readable media for scene creation using language models.

### BACKGROUND

Online gaming provides an opportunity for players to interact in a virtual environment and participate in a plurality of virtual experiences or games. Each player may access one or more virtual experiences, e.g., participating as an avatar that is in the virtual experience. Constructing such a virtual experience can be a complicated, cumbersome task. At present, gaming platforms require that developers who wish to construct a virtual experience have to manually select and place objects. It is difficult and inefficient to find and place objects in this manner.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of this application relate to scene creation for a virtual experience using language models.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method, comprising: receiving a user prompt, the user prompt comprising text criteria specifying for generation or modification of a virtual experience, wherein the user prompt is a natural language prompt that includes at least one of text data, audio data, or video data; identifying one or more objects in the virtual experience having one or more attributes that correspond to the text criteria, the one or more objects being identified by a large language model; determining spatial placement information in the virtual experience for the one or more objects by using the large language model to interpret the text criteria to determine locations for the one or more objects in the virtual experience; and placing the one or more objects in the virtual experience based on the spatial placement information.

Various implementations of the computer-implemented method are described herein.

In some implementations, the computer-implemented method further comprises modifying the virtual experience by changing an attribute of a specified object of the one or more objects in the virtual experience based on the text criteria, wherein the attribute comprises an appearance, a behavior, a position, an orientation, a style, a material, a texture, a cost, a property, or another modifiable aspect of the specified object.

In some implementations, the identifying of the one or more objects in the virtual experience comprises: generating one or more keywords using the large language model and performing a keyword search based on the keywords.

In some implementations, the placing comprises placing objects such that there is no overlap.

In some implementations, the user prompt comprises an updated prompt.

In some implementations, the computer-implemented method further comprises providing, to a user, at least one of a view of the virtual experience including the one or more objects as placed or a summary of changes made to the virtual experience.

In some implementations, the large language model uses at least one of scene context and a history of user prompts to perform at least one of identifying the one or more objects or determining the spatial placement information.

In some implementations, the large language model uses at least one macro obtained from the natural language prompt to perform at least one of identifying the one or more objects or determining the spatial placement information.

According to another aspect, a non-transitory computer-readable medium is provided. The non-transitory computer-readable medium with instructions stored thereon that, responsive to execution by a processing device, causes the processing device to perform operations comprising: receiving a user prompt, the user prompt comprising text criteria specifying for generation or modification of a virtual experience, wherein the user prompt is a natural language prompt that includes at least one of text data, audio data, or video data; identifying one or more objects in the virtual experience having one or more attributes that correspond to the text criteria, the one or more objects being identified by a large language model; determining spatial placement information in the virtual experience for the one or more objects by using the large language model to interpret the text criteria to determine locations for the one or more objects in the virtual experience; and placing the one or more objects in the virtual experience based on the spatial placement information.

Various implementations of the non-transitory computer-readable medium are described herein.

In some implementations, the operations further comprise modifying the virtual experience by changing an attribute of a specified object of the one or more objects in the virtual experience based on the text criteria, wherein the attribute comprises an appearance, a behavior, a position, an orientation, a style, a material, a texture, a cost, a property, or another modifiable aspect of the specified object.

In some implementations, the identifying of the one or more objects in the virtual experience comprises: generating one or more keywords using the large language model and performing a keyword search based on the keywords.

In some implementations, the placing comprises placing objects such that there is no overlap.

In some implementations, the large language model uses at least one macro obtained from the natural language prompt to perform at least one of identifying the one or more objects or determining the spatial placement information.

In some implementations, the user prompt comprises an updated prompt.

In some implementations, the operations further comprise providing, to a user, at least one of a view of the virtual experience including the one or more objects as placed or a summary of changes made to the virtual experience.

In some implementations, the large language model uses at least one of scene context and a history of user prompts to perform at least one of identifying the one or more objects or determining the spatial placement information.

According to another aspect, a system is disclosed, comprising: a memory with instructions stored thereon; and a processing device, coupled to the memory, the processing device configured to access the memory, wherein the instructions when executed by the processing device cause the processing device to perform operations including: receiving a user prompt, the user prompt comprising text criteria specifying for generation or modification of a virtual experience, wherein the user prompt is a natural language prompt that includes at least one of text data, audio data, or video data; identifying one or more objects in the virtual experience having one or more attributes that correspond to the text criteria, the one or more objects being identified by a large language model; determining spatial placement information in the virtual experience for the one or more objects by using the large language model to interpret the text criteria to determine locations for the one or more objects in the virtual experience; and placing the one or more objects in the virtual experience based on the spatial placement information.

Various implementations of the system are described herein.

In some implementations, the large language model uses at least one macro obtained from the natural language prompt to perform at least one of identifying the one or more objects or determining the spatial placement information.

In some implementations, the operations further comprise modifying the virtual experience by changing an attribute of a specified object of the one or more objects in the virtual experience based on the text criteria, wherein the attribute comprises an appearance, a behavior, a position, an orientation, a style, a material, a texture, a cost, a property, or another modifiable aspect of the specified object.

In some implementations, the identifying of the one or more objects in the virtual experience comprises: generating one or more keywords using the large language model and performing a keyword search based on the keywords.

In some implementations, the placing comprises placing objects such that there is no overlap.

In some implementations, the user prompt comprises an updated prompt.

In some implementations, the operations further comprise providing, to a user, at least one of a view of the virtual experience including the one or more objects as placed or a summary of changes made to the virtual experience.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1A is a diagram of an example system architecture for scene creation using language models, in accordance with some implementations.

FIG. 1B is another diagram of an example system architecture for scene creation using language models, in accordance with some implementations.

FIG. 2A is a diagram of an example of a generated virtual experience based on a first prompt, in accordance with some implementations.

FIG. 2B is a diagram of an example of the generated virtual experience of FIG. 2A further based on a second prompt, in accordance with some implementations.

FIG. 2C is a diagram of an example of the generated virtual experience of FIG. 2B further based on a third prompt, in accordance with some implementations.

FIG. 2D is a diagram of an example of the generated virtual experience of FIG. 2C further based on a fourth prompt, in accordance with some implementations.

FIG. 3 is a screenshot of an example of an entered user prompt and a corresponding scene generated based on the entered user prompt, in accordance with some implementations.

FIG. 4 is a flowchart of an example method for scene creation using large language models, in accordance with some implementations.

FIG. 5 is an example of how a user prompt is translated into a series of subtasks that create a scene using macros, in accordance with some implementations.

FIG. 6 is a diagram of how a user prompt is processed to create a scene, in accordance with some implementations.

FIG. 7A is a diagram of providing an example initialization prompt and an example instruction prompt to a large language model to determine available objects, in accordance with some implementations.

FIG. 7B is a diagram of providing the example instruction prompt and the available objects to a large language model along with examples of a good answer and a bad answer, in accordance with some implementations.

FIG. 8 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

One or more implementations described herein relate to scene creation associated with an online gaming platform, such as virtual experiences in a virtual environment. Features can include receiving a natural language user prompt, interpreting the natural language user prompt to identify one or more objects to place in the virtual experience, and placing the identified objects at appropriate locations. In general, a virtual environment may refer to a platform that hosts many virtual experiences by managing access to virtual experiences. The virtual experiences correspond to individual users' interactions with a platform that provides interactive games that the users can play.

Creating large scenes is hard for three-dimensional (3D) artists. It takes a lot of manual work to find proper assets and place them properly in the scene. Also, once the assets are placed, subsequent iteration is cumbersome. Implementations are described herein to provide methods for using large language models (“LLMs”) for generating scenes from user prompts. The user gives the application an input expressing what the user wants to build, e.g. “build a medieval village for me.”

Machine learning may be leveraged for a natural language processing (NLP) task to interpret a text-based prompt (or other prompt, including image, audio, video, or multimedia prompt) inputted by a user of a virtual environment. Algorithms, e.g. large language models based on techniques such as transformers, can be created to learn from data via training and to perform analysis of a prompt. Based on such prompt analysis, the large language models are able to respond in a manner that appears conversational.

### Using Large Language Models (LLMs) for Natural Language Processing (NLP)

Large language models (LLMs) are a type of language model known for their ability to achieve general-purpose language understanding and generation. These abilities come from using massive amounts of training data to learn huge numbers of parameters during training. A general purpose LLM can incorporate a significant amount of understanding and perform very well at many NLP tasks. However, it is also possible to perform “fine-tune” training where data specific to a particular application is used to further train a general LLM. Then, the fine-tuned LLM can perform well on that specific kind of data.

Once trained, LLMs take a prompt and repeatedly predict the next word/token. Such prediction allows LLMs to generate blocks of text in response to prompts. LLMs can include knowledge about syntax (rules for forming language), semantics (rules for meaning of language), and ontology (information about concepts and categories in a domain).

Features described herein provide ways to use a large language model to automatically, easily and efficiently identify objects to place in a virtual experience. The large language model also determines where to place the objects. Once the objects and appropriate locations are determined, the virtual experience is constructed accordingly. There may also be an opportunity for subsequent iterative interactions, in which a user may modify the initial placement of the objects (e.g., directly, or via follow-up queries to the LLM) or otherwise change one or more properties of the placed objects to change the virtual experience as desired.

Implementations provide a conversational artificial intelligence (AI) that will enable creators and users to tap into a vast variety of capabilities quickly and intuitively. Implementations orchestrate various capabilities/Application Programming Interfaces (APIs) to solve tasks for creators in a cohesive way. APIs provide for specified ways for modules to interact with one another. APIs define a standard of rules that regulate communication between software modules. Implementations may operate in a variety of contexts. Hence, implementations may be built in a highly modular API-first way to ensure flexibility in a rapidly changing technical environment.

Implementations may provide a cloud service that enables a conversational AI to interface between a user and corresponding APIs/capabilities. The conversational AI will act as an orchestration layer, enabling access to a large variety of capabilities. For example, the conversational AI may provide a service for scene creation, allowing easy creation of virtual experiences. Such a service may be accessed in-experience, in a developer application such as a studio or virtual experience creation application, or on the web, and may be extended to third-party services.

### Discussion of Use Cases

There may be a variety of possible use cases for these techniques. For example, the user may be a new creator or an experienced creator. If the user is a new creator, the user may want to create something interesting quickly or may want to learn how to use a specific feature or capability. Alternatively, an experienced creator may want to quickly build out a new level for an existing game, may want to rapidly scale an existing game to a larger world, or may want to re-style and re-purpose game objects at scale. Thus, users may be able to quickly create worlds and refine their creation skills, or may refine and scale existing creations more easily.

In addition to placement of objects in a virtual experience, the conversational AI may have many types of applications for allowing a user to successfully interact with the virtual experience. For example, the AI may provide for documentation tasks. In documentation tasks, the prompt poses a question about how to perform a task in the virtual environment and the AI answers the question. The AI may also provide for analytics tasks. In analytics tasks, the prompt requests information about usage data and metrics and the AI provides such information.

The AI may also provide for scripting tasks. In scripting tasks, the prompt includes instructions for a script to be associated with object(s) and in response to a prompt requesting a script for an object, the AI may generate the script. The AI may also provide for world building tasks. In world building tasks, the prompt describes a setting to be used as the basis of a virtual experience and the AI constructs the setting. The AI may also provide for user interface tasks. In user interface tasks, the prompt requests that the AI construct an interactive user interface for a player to interact with the virtual experience and the AI generates output that specifies the user interface, e.g., objects within the user interface, their position, transitions between different parts of the UI, etc. The AI may also provide for audio/music tasks. In audio/music tasks, the prompt specifies music and/or sounds to associate with portions of the virtual experience and the AI performs the association.

The AI may also provide for settings tasks. In settings tasks, the prompt requests a change to game setting(s) and the AI changes such setting(s). The AI may also provide for in-experience tasks. In in-experience tasks, the prompt specifies the nature of an intelligent construct for the experience, such as a conversational NPC and the AI develops a corresponding construct. The AI may also provide for trust and safety tasks. In trust and safety tasks, the prompt provides for ways to report bad behavior and the AI establishes reporting protocols. The AI may also provide for accounts tasks. In accounts tasks, the prompt specifies tasks to use with respect to user accounts and the AI performs the tasks. The AI may also provide for extensibility tasks. In extensibility tasks, the prompt specifies a way to use extensions to the existing virtual environment (such as requesting plugins) and the AI integrates the extensions.

The conversational AI may interact with facilities for context understanding, AI skills, engine APIs, and open cloud APIs. For example, the context understanding may consider user text input as well as the current scene graph. The AI skills may consider GenAI modeling and GenAI texturing, allowing for successful intelligent management of object properties (such as modeling and texturing). The engine APIs may include a mesh API and a texture API, which provide for successful managements of meshes and textures when placing objects.

### Use of Conversational Artificial Intelligence (AI)

In order to create the scenes, a user provides a natural language prompt. The natural language prompt has a meaning that allows the prompt to suggest a list of relevant object(s) and ways to place instances of those object(s). For example, the natural language prompt may be a request to arrange houses near a road, with a mountain in the distance.

Appropriate object(s) are identified for building the scene and used along with a search API for finding corresponding object(s) to place in the virtual experience. For example, the system interprets the prompt to formulate a query including keywords to search and the search system uses the API to give it object(s) most relevant to that query. Then, the system, using the large language model, decides on the configuration of the objects and returns that in a pre-specified format. Then a developer application or another appropriate 3D environment modeling software places those objects according to the specified instructions. Accordingly, the user receives a virtual experience corresponding to what he or she asked for.

Once a scene is created, the user can also make further modifications to the scene very easily with additional natural language commands. This ability is another benefit of this method (in contrast to manually going and making all of the subsequent changes). For example, the user can say “make the medieval village made of eskimo houses.” Hence, the provided approach establishes an easy way for the user to easily construct an initial virtual experience and easily make further desired changes.

The methods presented in the implementations described herein may also be applied to other use cases of 3D generation in virtual experiences like terrain generation. While implementations involving placing objects in a virtual experience based on a prompt are presented in great detail, implementations are not limited to such a use case. Essentially, any sort of configuration generation can be done using conversational AI. Such alternative tasks could include tasks like user interface (UI) generation, property modification, and script generation.

Thus, the generation workflow according to some implementations essentially includes the following operations. The workflow begins with a natural language user prompt. For example, the user may type in, “Generate a village.” The user prompt is provided to a large language model (for example, one of the large language models discussed above, such as a version of Generative Pre-Trained Transformer (GPT)). However, the large language model used is not limited to GPT, and other large language models from other vendors that are designed to process natural language prompts that are trained on large amounts of training data that have large numbers of parameters (e.g., hyperparameters) may also be used in various implementations, instead of or in addition to GPT.

Pre-trained LLMs already have knowledge built-in through the training process and the billions of resultant parameters and can perform reasoning or summarization tasks such as “generate keywords from the following three paragraphs” or “summarize the following text.” This capability is how an LLM maps user prompts to keywords for object searching. Additional application-specific adaptations (such as for a virtual game environment) may be (a) using a search keyword corpus (from developer searches for objects) as additional training data to customize model vocabulary to cover virtual environment-specific terms as well as object attributes; (b) providing descriptive text (from virtual environment developers) about all objects in the virtual environment as training input to the LLM. Other application-specific training is also possible.

Because the LLM will be providing instructions that are suitable for modifying virtual experiences in a virtual environment, it is extremely easy to edit scenes, as this is a core feature of such an environment. Thus, it is easy for the LLM to provide instructions that provide for a substantial portion (about 80% or more) of the construction tasks. Then the user can finish creating a virtual experience through additional prompts or manual editing of the virtual experience in the virtual environment.

The large language model considers the prompt and identifies objects related to the prompt based upon its built-in understanding of the meaning of the prompt. For example, the LLM may consider that a “village” may include “road” and “house” objects. These objects are then provided again to an LLM (which may be the same LLM or another LLM). The LLM considers the identified objects and determines how to place the objects to create in the scene. For example, the LLM may provide a list of object identifiers and corresponding placement coordinates.

Once the LLM produces this list, the virtual experience receives the list and the virtual experience is constructed based on inserting the objects into the scene appropriately. For example, the LLM may generate macros that correspond to instructions for inserting one or more objects, and these macros allow construction of the virtual experience. Greater details about these workflow operations, including specific examples of placement instructions and macro usage, are presented in accordance with the drawings below.

Once objects have been identified, their placement and orientation can be determined automatically using the LLM. For example, a “floor lamp” object would be placed on the floor by default. A “car” object could be on a road/garage by default, based on the reasoning functionality of the LLM. However, these defaults could be overridden by using specific instructions. For example, while a “car” might ordinarily be on a road/garage, it could also be in a showroom if the virtual experience is a virtual car dealership or if the user provides explicit alternative instructions and/or prompting.

In various implementations, it is possible to use a single unified LLM to both identify objects corresponding to the prompt and to determine spatial placements for these objects based on considering the prompt. However, it is also possible to perform these tasks using multiple LLMs. Also, in some implementations these LLM(s) may operate without fine-tuning. A trained general LLM still does quite well at the placement task, due to the large amounts of knowledge already inherent to a trained general LLM.

Hence, such a trained general LLM may perform the transitions between the high level workflow operations of “receive prompt”-> “identify objects”-> “place objects and generate scene.” The trained general LLM may also perform subsequent functions of “receive user feedback”-> “update scene.” However, these last two operations are an extension of the other operations and may be optional.

Placement may also rely upon metadata about objects. For example, this metadata could include sizes, orientation, sub-objects, and characteristics of objects. Hence, the metadata could include information about the nature of the object, which could suggest ways to successfully place objects in a way that is consistent with the prompt and with the nature of other objects being placed, as well as other contextual information. Additionally, a higher ranking could be assigned to objects with more metadata, as having more metadata available could make it easier to place such objects effectively.

For example, updating the scene may include styling of objects. Styling includes generating new styles and applying them to selected objects. Such styling may include material generation and mesh retexturing, as examples. Either based on user input or a determination using AI analytics, a decision is made if a style change is needed or not. For example, if the object retrieved is a brick house and the prompt requests a brick house, no styling is necessary because the house is already made of bricks.

Thus, the user may provide a single prompt or a series of prompts to create a virtual experience by using natural language instruction(s) that are interpreted to infer aspects of the desired virtual experience. Workflows could be bottom-up or top-down. In bottom-up workflows, a foundational object is placed and a scene is created around such a foundational object. In top-down workflows, high-level groups of objects are situated and subsequent prompts refine the objects to cause them to conform to aspects of the scene.

### Summary of Operational Features

For implementations to operate successfully, a number of features and capabilities may be enabled. For example, the routing and orchestration may include intent detection (to better interpret the prompt), agent selection (to determine effective ways to implement the prompt), and chaining (to relate aspects of the prompt to one another). There may be multimodal input, such as text, voice, image, and video. There may be context considered, such as chat history, scene, scripts, selection, and webpage. Such context implements the prompt in a way that better represents user intent. There may be first party extensibility, such as first party conversational UI creation and first party service registration. These capabilities allow adding additional capabilities and performance improvements.

There may also be cloud/client coordination functionality. Such coordination could include coordinating engine APIs, coordinating cloud services, coordinating a developer application-only capabilities, and coordinating Web only capabilities. The coordination would allow for different contexts to interact more effectively when the conversational AI is used to construct virtual experiences. There may also be customization for individual contexts, such as limitation of capabilities, changing name/personality, and enabling voice activation of capabilities. Context could also consider user preferences in a marketplace, descriptions and attributes of a scene, and creator experience level. These aspects could help customize user experience to an individual user.

### Discussion of Features

Implementations provide various categories of features for virtual experience construction and refinement. These features could include placement/insertion features, material generation features, retexturing features, terrain generation features, behavior features, and cost estimate features.

Placement/insertion features could include single-object insertion, query expansion (used to identify objects), multi-object insertion, a multi-item selection UI, low fidelity placement, placing an item correctly on terrain, object orientation, object understanding, explaining tasks automatically performed by the AI, data collection (used to measure success), scene understanding, inserting objects from inventory, revising a scene by bulk editing, procedural creation, editing object properties, swapping items, suggestions for next operations, high fidelity placement, connection features to material generation, multimodal input, and features for providing instructions.

Material generation features could include generating and applying a single material, generating several images from a single material generation prompt, applying a material from the chat UI, saving a material from the chat UI, opening a material generator from the chat UI, assisting the user in editing a material, chaining material generation with other capabilities, when chained, generating just one material and applying it as part of the chain, when chained, providing a handle in chat UI to edit the material, adjusting studs per tile in chat UI, providing an image input to guide material generation, replacing a material, applying a material to a complex object, replacing a surface appearance with a material, and refining a material variant.

Texturing features could include creating a texture for mesh objects, creating a texture for parts, such as when using Constructive Solid Geometry (CSG), creating a texture for an object from text, and creating a texture for an object from an image. Terrain generation features could include terrain placement and terrain mesh generation. Behavior features could instruct an NPC to take actions, such as movement and actions (such as attacks). Cost estimate features could track current tokens per query and/or track price per token.

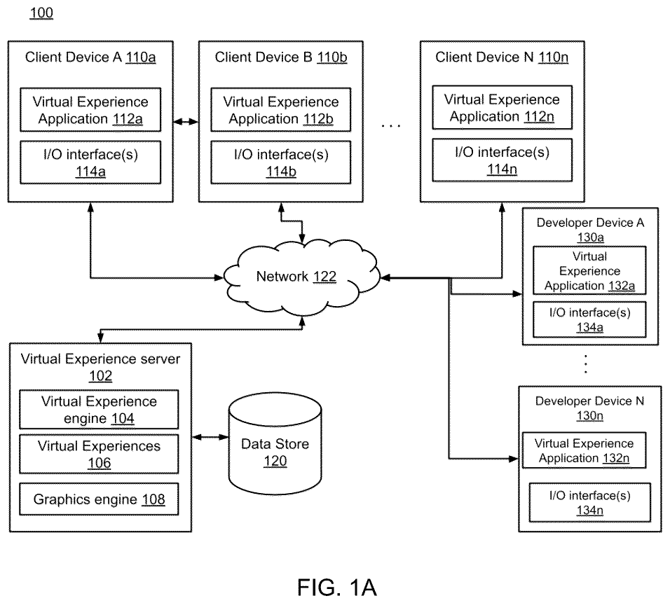

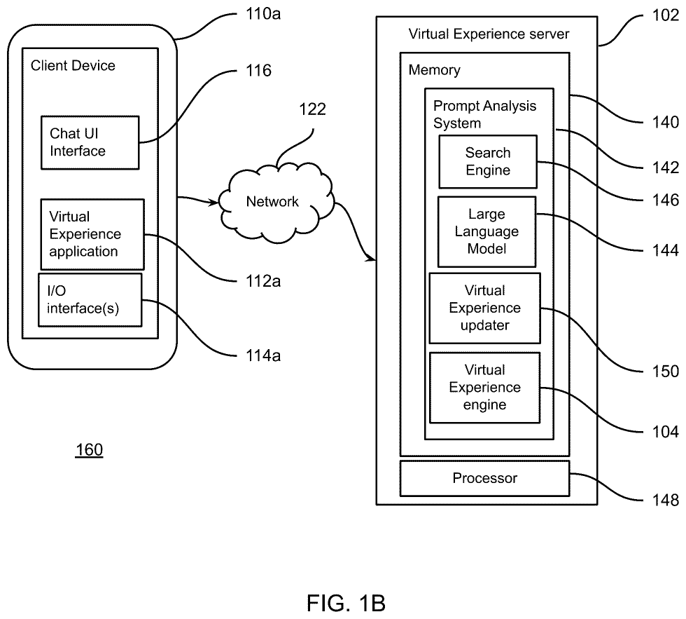

### FIGS. 1A-1B: Example System Architecture

FIG. 1A is a diagram of an example system architecture 100 for scene creation using language models, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102 (also referred to as “virtual experience server 102” herein), data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

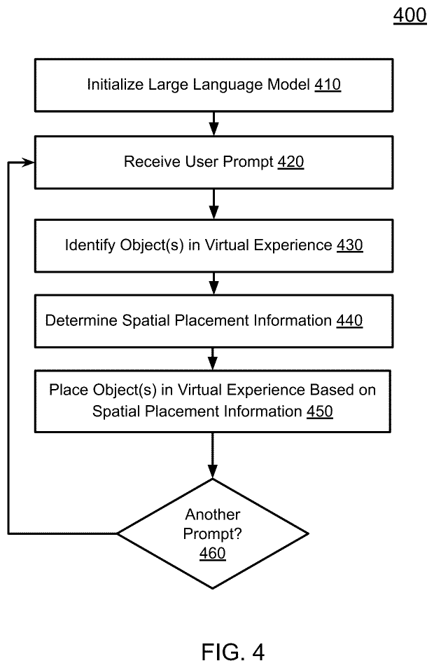

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 4. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1A.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations, the chat transcripts are generated via virtual experience application 112 and/or virtual experience application 132 and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online gaming server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multi-participant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g. shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g. shirts, pants, etc. the online virtual experience platform may provide users access to simplified 3D virtual object models that are represented by a mesh of a low polygon count, e.g. between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

FIG. 1B is another diagram of an example system architecture for scene creation 160 using language models, in accordance with some implementations of the disclosure. The system architecture 160 (also referred to as “system 160” herein) is a variant of that of FIG. 1A that includes client device 110a, virtual experience server 102, and network 122. FIG. 1B shows an instance of the system architecture 160 that includes a client device 110a communicating with a virtual experience server 102 using network 122.

System architecture 160 is provided for illustration. In different implementations, the system architecture 160 may include the same, fewer, more, or different elements configured in the same or different manner as that shown in FIG. 1B.

For example, the client device 110a may include additional elements such as a Chat User Interface (“chat UI”) 116. The chat UI 116 allows the user to enter a natural language prompt that can be used to instruct the virtual experience server 102 how to provide a virtual experience for the user of the client device 110a. The chat UI 116 may provide several capabilities for modifying the virtual experiences 106. The chat UI 116 may allow for insertion, object selection, swapping and revising scenes, and styling. The chat UI 116 provides for an interactive experience in which the user enters a prompt, the chat UI 116 sends the prompt for interpretation and implementation at the virtual experience server 102, and the chat UI 116 explains how the implementation occurs. The chat UI 116 can also provide an iterative experience, in which the user provides multiple prompts to progressively refine a virtual experience.

Thus, the chat UI 116 shows its work by presenting an explanation of what it did in response to a user prompt. The chat UI 116 should also show options, such that when a user's intent is unclear or could be interpreted in multiple ways, the chat UI 116 will interact with the user to assess what the user's actual intention is. For example, the chat UI 116 could show several candidate objects and allow the user to select a preferred object.

The virtual experience application 112a is an application that provides the client device 110a with an interface that allows a user of the client device 110a to access a virtual experience hosted by the virtual experience server 102, such as by virtual experience engine 104. In some implementations, the chat UI 116 is integrated into virtual experience application 112a. In other implementations, the chat UI 116 is separate from virtual experience application 112a, and is hosted separately at client device 110a. In other implementations, chat UI 116 and virtual experience application 112a are hosted on separate client devices, in lieu of the single client device 110a shown in FIG. 1B.

Depending on the nature of client device 110a, chat UI 116 and virtual experience application 112a may be implemented in various ways. For example, client device 110a may be a computing device that allows a user to interact with a virtual experience provided based on a virtual environment hosted by the virtual experience server 102, such as by virtual experience engine 104. For example, client device 110a may be a smartphone, a tablet, or a notebook PC. The client device 110a may host the chat UI 116 and virtual experience application 112a as desktop application(s), mobile app(s), or through a Web browser run by client device 110a.

Client device 110a may also include input/output (I/O) interfaces 114a (e.g., input/output devices). The input/output devices can include one or more of a microphone, speakers, headphones, display device, mouse, keyboard, game controller, touchscreen, virtual reality consoles, etc. These I/O interfaces 114a may provide the client device 110a with the capability to interact with the user for accessing the chat UI 116 and the virtual experience application 112a.

The user prompt received by the chat UI 116 may be sent to the virtual experience server 102. For example, the user prompt is transmitted across network 122 to virtual experience server 102. In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

The virtual experience server 102 includes processor 148 that accesses the prompt analysis system 142 stored in a memory 140 and may perform one or more of the described operations to identify keywords corresponding to the user prompt. The processor 148 may also implement a virtual experience updater 150 and a virtual experience engine 104 stored in memory, as described further below. These keywords may help identify relevant objects in the virtual experience.

In some implementations, the memory 140 may be a non-transitory computer readable memory (e.g., random access memory), a cache, a drive (e.g., a hard drive), a flash drive, a database system, or another type of component or device capable of storing data. The memory 140 may also include multiple storage components (e.g., multiple drives or multiple databases) that may also span multiple computing devices (e.g., multiple server computers). In some implementations, memory 140 may include cloud-based storage.

For example, the prompt analysis system 142 may include a search engine 144, a large language model 146, a virtual experience updater 150, and a virtual experience engine 104. While these elements (a search engine 144, a large language model 146, a virtual experience updater 150, and a virtual experience engine 104) are characterized as being part of the prompt analysis system 142, they may also be part of a more generalized structure of the virtual experience server 102.

These modules may communicate freely with each other in order to perform their respective tasks. Additionally, one or more of these modules may be hosted on another computing platform that is in communication with virtual experience server 102. Further, any additional computing resources needed for the successful functioning of these modules, such as additional processing, memory, or durable storage, as well as any necessary input/output devices, may be provided as being disclosed by this disclosure. Also, any additional modules necessary for the successful completion of the tasks provided for by these components may be provided in addition to or instead of the explicitly provided modules.

The prompt is provided to the large language model 144, which transforms the prompt into keywords. These keywords are then provided to the search engine 146, which performs a search and identifies objects from the virtual environment that are related to the prompt, based on considering the keywords. The list of objects is then provided again to the large language model 144 for further consideration. The large language model 144 determines how to construct a virtual experience, based on processing the prompt again and considering the list of objects.

In some implementations, the large language model 144 receives a user prompt from client device 110a. The user prompt includes text criteria specifying how to modify the virtual experience. The user prompt may be a natural language prompt provided using at least one of text data, audio data, and video data. However, other implementations contemplate prompting using images as input. Prior to receiving the prompt, the large language model 144 is pre-trained on a large corpus, allowing the large language model 144 to have a generalized ability to receive language and respond conversationally, based on having inherent knowledge derived during the pre-training.

In some implementations, the large language model 144 may also be fine-tuned on domain-specific data. Prior to receiving the user prompt, the large language model 144 may also receive an initialization prompt instructing the large language model 144 the format of subsequent instructions it will receive and an indication to interpret the subsequent instructions as instructions to create a scene by placing objects or modifying a created scene.

Hence, the large language model 144 takes the user prompt from the client device 110a and identifies a list of keywords corresponding to the response by using its built-in knowledge. The large language model 144 may include in the list of keywords exact words and phrases included in the prompt that are appropriate keywords, and may also include keywords that are not explicitly recited in the user prompt, but are determined by the large language model 144 to be effective for finding objects that are related to scene described by the prompts. Examples of how the large language model 144 identifies the keywords are provided below in subsequent drawings that illustrate the operation of certain implementations.

In some implementations, the search engine 146 takes the keywords identified by the large language model 144 and uses them to identify relevant objects. In some implementations, the search engine 146 uses the keywords to search an online marketplace or a user's inventory. The search engine 146 may operate using an appropriate API.

This search may result in a number of hits (for example, five to ten hits per keyword) providing objects corresponding to the result of interpreting the user prompt using the large language model 144. Hence, the search engine 146 may provide results that specify objects that are candidates for placement in a virtual experience. The search engine 146 may also include and use other information when searching, such as scene context, history, object metadata, and so on.

In some implementations, the virtual experience updater 150 handles updating the virtual experience updater 150. In general, the updating uses information from a large language model 144. Hence, the virtual experience updater 150 may be able to perform the updating by using the results of the search engine 146. Such results may be used in combination with using the large language model 144 to identify where the identified objects are to be placed in the virtual experience.

The virtual experience updater 150 places the objects accordingly. For example, the large language model 144 generates instructions for the use of the virtual experience updater 150 to use. The virtual experience updater 150 may place one object at a time, or may use macros to place multilingual objects simultaneously. The prompts may also cause the virtual experience updater to change an existing aspect of the virtual experience. When the virtual experience updater 150 is done, the virtual experience includes appropriate changes.

In some implementations, the virtual experience engine 104 hosts the virtual experience as updated by virtual experience updater 150. The virtual experience engine 104 provides access to the virtual experience to a user of the client device using game application 114. For example, the network 122 may connect the client device 110a with game server 120. Once the virtual experience has been constructed, the game server 120 provides access to the virtual experience (as hosted by the virtual experience engine 104) using the game application 114.

As noted, there may be further prompts received using chat UI 116. These prompts may be interpreted to create alternative virtual experiences, or to further modify the created virtual experience. The additional prompts may be interpreted by identifying objects and placing them as before, or by identifying objects and modifying existing objects accordingly.

Further details about what the large language model 146 accomplishes and how it accomplishes these tasks are provided, below. After the virtual experience is constructed, it is provided to the client device 110a using network 122. For example, virtual experience application 112a provides the user with the ability to view the constructed virtual experience. Additionally, chat UI 116 may provide a summary or explanation of which objects were placed and how they were placed.

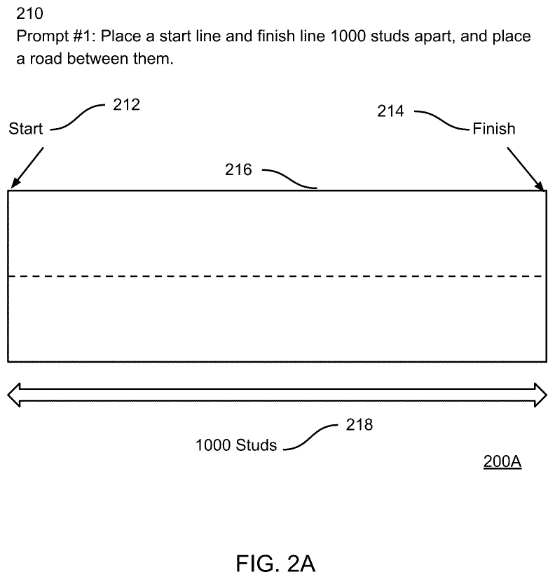

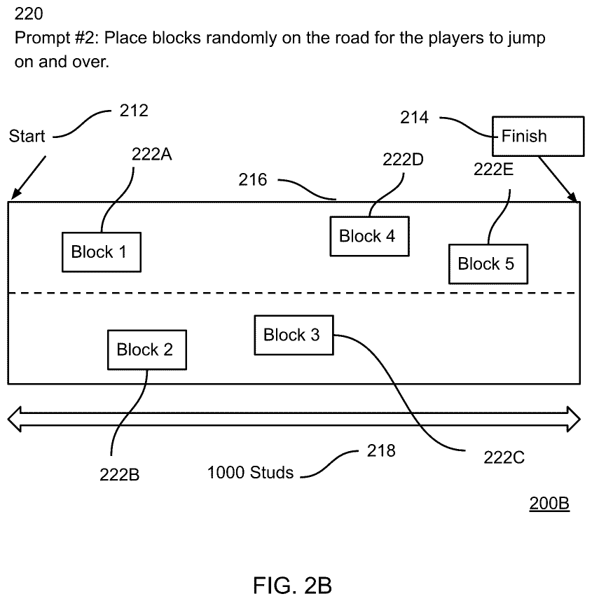

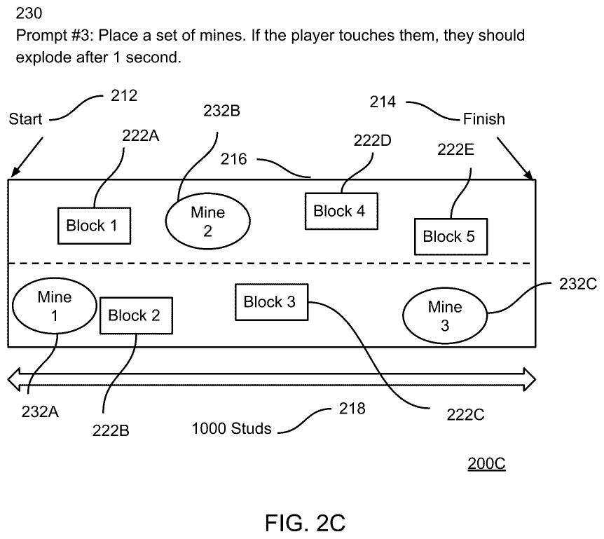

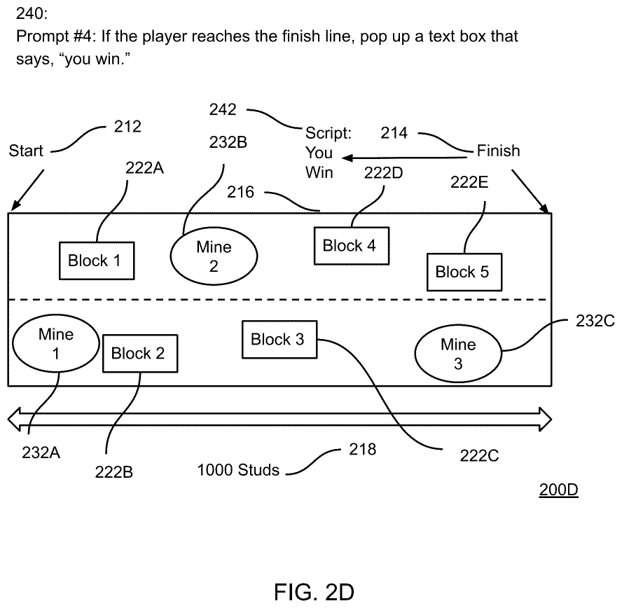

The prompt analysis is not limited to a single prompt or a single iteration. For example, after the initial prompt is implemented and a virtual experience has been created, additional changes can be made to the results. For example, chat UI 116 may receive another prompt for further analysis by prompt analysis system 142 at the virtual experience server 102. The subsequent prompt is then analyzed by the large language model 146, which can provide additional changes to the virtual experience, which can then be viewed as updated in virtual experience application 112a. An example of an iterative interaction is presented, below, in FIGS. 2A-2D.

### FIGS. 2A-2D: Simple Example Use Case

FIG. 2A is a diagram 200A of an example of a generated virtual experience based on a first prompt 210, in accordance with some implementations. FIG. 2A illustrates the results of receiving a first prompt 210 “Prompt #1: Place a start line and finish line 1000 studs apart, and place a road between them.” The first prompt 210 may be interpreted by a large language model. As an initial operation, the large language model can process the first prompt 210 and realize that the objects to place are “start line,” “finish line,” and “road.”

The large language model further determines to place start 212 and finish 214 on either side of a road 216. The large language model is also able to determine that the start 212 and finish 214 should be 1000 Studs 218 apart. Here, Studs are a sample unit of linear distance in a virtual environment. Hence, other units of linear distance could be used, as appropriate. The large language model may also be able to infer additional information about the desired virtual experience. For example, the large language model may infer that road 216 may be a straight road divided into two lanes.

FIG. 2B is a diagram 200B of an example of the generated virtual experience of FIG. 2A further based on a second prompt 220, in accordance with some implementations. FIG. 2B illustrates the results of receiving a second prompt 220 “Prompt #2: Place blocks randomly on the road for the players to jump on and over.” Before second prompt 220, the results of first prompt 210 are already present in the virtual experience.

The large language model determines that the object to place is blocks (such as roadblocks). The large language model also determines that the prompt requests that the blocks be placed “randomly.” Thus, the large language model should determine a random number of blocks to place. In the example of FIG. 2B, the large language model determines to place five blocks. The five blocks 222 are block 1 222A, block 2 222B, block 3 222C, block 4 222D, block 1 222E. As shown, the five blocks 222 are placed randomly on road 216.

FIG. 2C is a diagram 200C of an example of the generated virtual experience of FIG. 2B further based on a third prompt 230, in accordance with some implementations. FIG. 2C illustrates the results of receiving a third prompt 230 “Prompt #3: Place a set of mines. If the player touches them, they should explode after 1 second.” Before third prompt 230, the results of first prompt 210 and second prompt 220 are already present in the virtual experience.

The large language model determines that the object to place is mines. There is no information about quantity or distribution. The large language model may thus default to determining that the prompt requests that the mines be placed randomly. In another implementation, the default could be an organized pattern. Also, the large language model should determine a random number of mines to place. There could also be a default number of mines in “a set.”

In the example of FIG. 2C, the large language model determines to place three mines. The three mines 232 are mine 1 232A, mine 2 232B, and mine 3 232C. As seen, the three mines 232 are placed randomly on road 216. However, the third prompt 230 is not limited to specifying placement of the three mines 232. It also specifies that the mines explode upon contact. Hence, the large language model associates a script with each mine to detect contact with a player's avatar and trigger the mine to explode after 1 second when such contact occurs.

FIG. 2D is a diagram 200D of an example of the generated virtual experience of FIG. 2C further based on a fourth prompt 240, in accordance with some implementations. FIG. 2D illustrates the results of receiving a fourth prompt 240 “Prompt #4: If the player reaches the finish line, pop up a text box that says, ‘you win.’” Before fourth prompt 240, the results of first prompt 210, second prompt 220, and third prompt 230 are already present in the virtual experience. Like third prompt 230, fourth prompt 240 affects the behavior of an object. However, the fourth prompt 240 does not actually place a new object. Instead, fourth prompt 240 modifies a property of the finish 214 object. The modification is associating a script 242 with the finish 214 object. The script 242 detects contact between a player avatar and the finish 214, and the contact leads to a display of the text “You Win.”

Thus, the four prompts provided in FIGS. 2A-2D are interpreted to create a simple racing game. In an alternative example, the prompts may create a lumber collection game. For example, such a lumber collection game could be created using a prompt to create a house, a prompt to place trees surrounding the house, a prompt to place trees in an area, a prompt to add flowers and bushes, a prompt to associate a script with the trees, and a prompt to construct a scoreboard.

In another alternative example, the prompts may create a medieval castle. For example, such an example scene may be created using prompts to build the castle. The prompts could include an instruction to build a castle having various attributes (such as a material and an associated object), a prompt asking about a drawbridge, a prompt adding torches, a prompt adding behavior to the torches, and a prompt adding cannons and an explanation of scripts associated with the cannons. Each prompt could include additional content giving guidance about how to perform operations that implement the prompt.

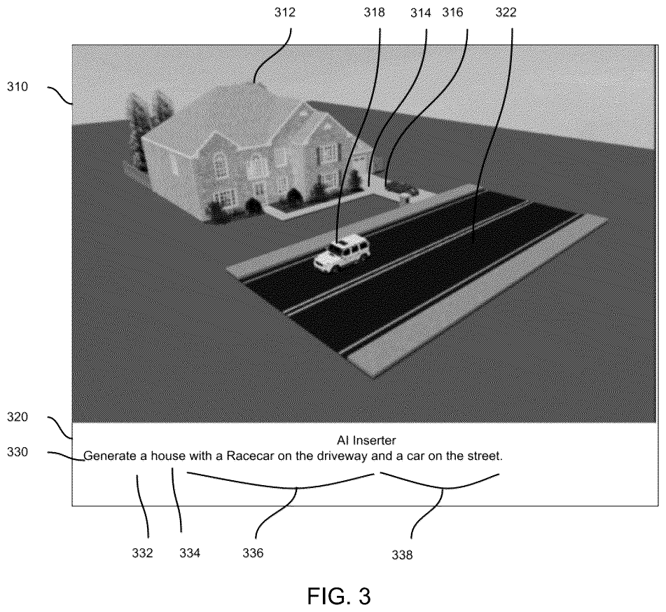

### FIG. 3: Screenshot of Use Case

FIG. 3 is a screenshot 300 of an example of an entered user prompt 330 and a corresponding scene generated based on the entered user prompt, in accordance with some implementations. The screenshot 300 includes two portions, view 310 and interface 320. For example, the view 310 provides a user with an illustration of a current version of the virtual experience. The interface 320 (labeled as “AI Inserter”) includes a prompt 330 entered by the user. For example, the prompt 330 may be “Generate a house with a Racecar on the driveway and a car on the street.”

The view 310 may have corresponding objects that represent a view of what a constructed virtual experience looks like through a view 310 after implementing the prompt 330. For example, the view 310 shows an isometric view of a house 312, the house 312 having a driveway 314 with a racecar 316 in the driveway 314. The view also shows a car 318 situated on street 322. These elements are added to the virtual experience corresponding to the view 310 by analyzing the structure of the prompt 330 to identify corresponding objects and place them properly in the scene.

For example, the large language model may divide the prompt 330 into tokens and group the tokens to process the prompt 330. For example, the large language model may identify “Generate” as group 1 332, “a house” as group 2 334, “with a racecar on the driveway” as group 3 336, and “and a car on the street” as group 4 338. The large language model may then map these groups of tokens and interpret their meanings to produce the appropriate components of the virtual experience.

For example, group 1 332 interprets “Generate” to mean that the remainder of the prompt will specify objects to be placed in the virtual experience. Group 2 334 interprets “a house” as indicating that there should be a house 312 in the view 310. The large language model may search based on the recitation of “house” and determine a particular object that should be situated as the house. For example, house 312 may be interpreted as having a certain number of floors, arrangements of windows and doors, and so on.

Likewise, the large language model may search based on the recitation of “with a racecar on the driveway” in group 3 336 and determine a particular object that should be situated as the racecar 316. For example, automobile 316 may be interpreted as being an automobile designed as a racecar 316. The automobile may also be interpreted as having a certain number of doors, paint color, styling, and so on.

Further, the large language model may search based on the recitation of “a car on the street” in group 4 338 and determine a particular car 318 that should be situated on a road segment 322 in front of the house 312. For example, car 318 may be interpreted as having a certain number of doors, paint color, styling, and so on. Whereas the automobile 316 is shown as a dark race car, car 318 is shown as a white Sports Utility Vehicle (SUV). The car 318 is positioned on a road segment 322. The road segment 322 adjoins the driveway, and aligns with a street in front of the house 312.

Hence, FIG. 3 shows a screenshot of what a simple example of a natural language instruction prompt 330 would look like in a virtual experience. One aspect of FIG. 3 to note is that using the large language model 330 to interpret the prompt automates a significant portion of the scene creation. However, this approach relies upon the large language model 330 to automatically make many decisions about how to make the placement. For example, the prompt specifies the “house,” the “racecar,” the “driveway,” and the “street.” However, it is still necessary to identify the particular objects associated with these portions of the prompt, as well as their exact locations and attributes.

Many alternative virtual experiences could plausibly be built that satisfy the same prompt 330. A noteworthy aspect of what is shown in FIG. 3 is that the view 310 is a plausible, reasonable interpretation of the provided prompt. Even if further modifications are desired by the user, it is relatively easy to make such modifications, either by using and interpreting additional prompts or by using existing tools in a virtual environment that allow a creator to manage details of a virtual experience.

For example, suppose that FIG. 3 produces view 310. The user may wish car 318 to be dark gray instead of white. Solely based on prompt 330, there would be no specific reason for the large language model to think that the car 318 has to be dark gray instead of white. However, another prompt or use of the proper editing tool could quickly fix this issue, if the remainder of the virtual experience is considered acceptable.

### FIG. 4: Flowchart of Example Method of Scene Creation

FIG. 4 is a flowchart of an example method for scene creation using large language models 400, in accordance with some implementations. In some implementations, the scene creation involves receiving a natural language prompt. A large language model may be pre-trained to process the natural language prompt in a way that will allow an inference of objects to place in a 3D scene, such as a virtual experience. The example method is performed in the context of a system that supports the operation of an appropriate virtual environment. Such a virtual environment hosts one or virtual experiences for users of the virtual environment.

For example, a user may use a client device 110a to interact with a virtual experience server 102 over a network 122. Here, the client device 110a provides relevant information about a user prompt to the virtual experience server 102. The virtual experience server 102 takes the user prompt and interprets it in ways that facilitate creating a virtual experience. By using the large language model, such interpretation can incorporate large amounts of inherent knowledge that permit a deep understanding of the prompt. Such a deep understanding of the prompt allows the prompt to contribute to an automated construction of the virtual experience in an easy way.

In block 410, the large language model is initialized. For example, a prompt may be provided to the large language model that details how the large language model is to receive prompts and generate virtual experiences based on those prompts. In some implementations, the prompt may inform the large language model that its task is to place objects on a 2D map. However, a prompt may indicate a slightly different goal in certain other implementations.

The prompt also informs the large language model what its input is. For example, the input may be a list of objects along with dimensions. The prompt also specifies a goal task, which may be placing objects with an object type and a corresponding coordinate. The prompt may also specify caveats while placing objects, such as that overlap is not permitted. Block 410 may be followed by block 420.

In block 420, the system receives a user prompt. The user prompt is a natural language prompt that specifies how to create a scene in a virtual experience. The user prompt is written to specify a scene by indicating how to place objects in a virtual experience. For example, the user prompt may specify specific objects to place in the virtual experience. However, the user prompt may also specify a type of scene and the system will be able to infer which particular objects are to be placed in the scene. Various examples of the prompts are shown in association with some of the figures presented herein.

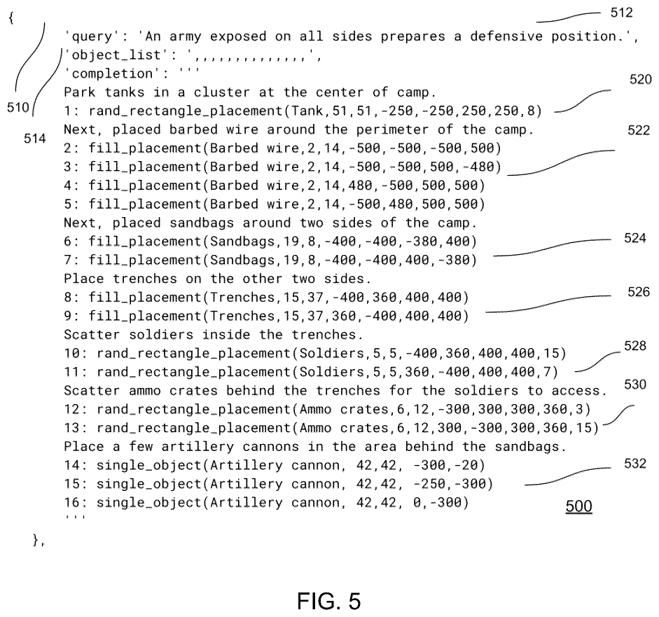

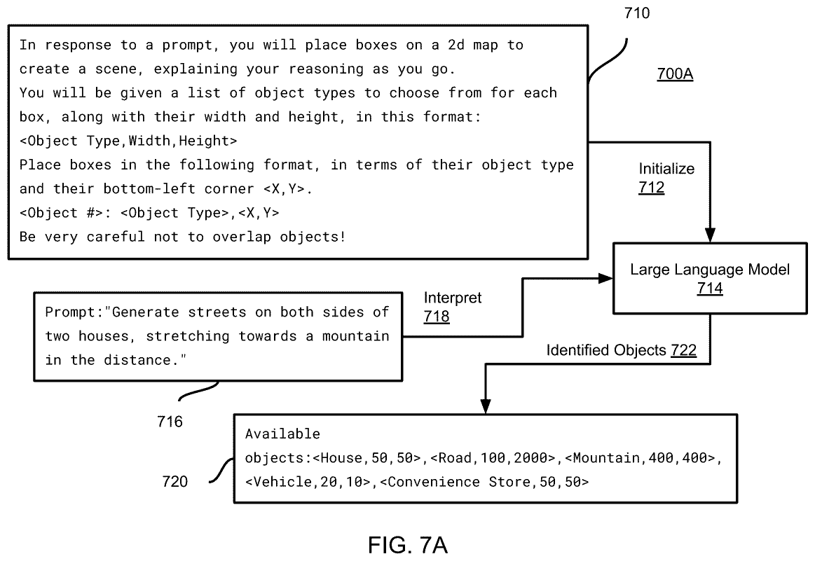

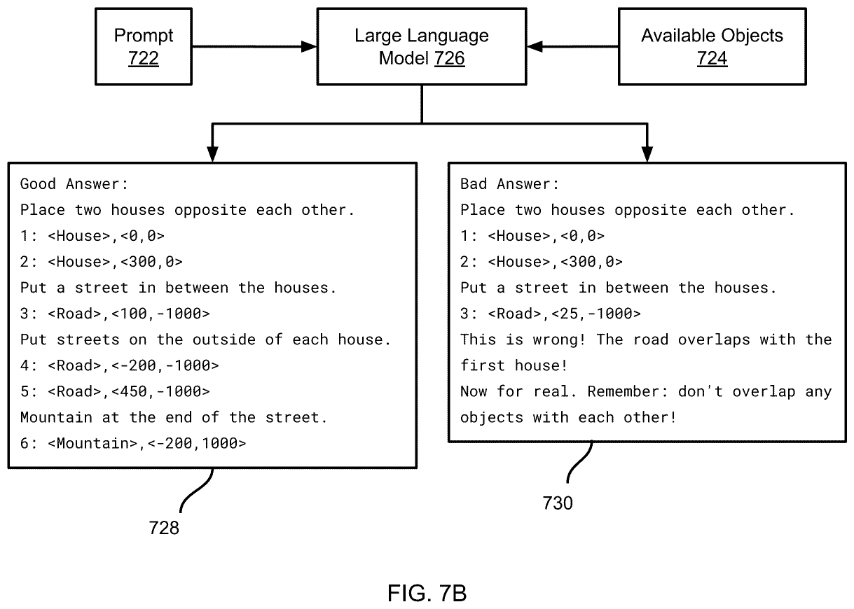

For example, FIGS. 2A-2D shows a series of prompts 210, 220, 230, and 240, FIG. 3 shows prompt 330, FIG. 5 shows prompt 512, and FIG. 7 shows prompt 716. Each of these prompt(s) provides a description of a scene to create. In general, a prompt will describe, in natural language, a scene to create. The prompt will generally be entered at a client device (such as client device 110a) and sent to a virtual experience server (such as virtual experience server 102) so that the virtual experience server 102 may interpret the prompt. Hence, block 420 contemplates having the game server receive a prompt from the client device for further processing and interpretation. Block 420 may be followed by block 430.

In block 430, the system identifies object(s) in a virtual experience. The identification includes two aspects. First, the system processes the prompt to identify keywords. Further examples of this process are provided below. For example, FIGS. 5 and 7A show examples of inferring keywords from a prompt and then using these keywords to identify corresponding objects in the virtual experience. For example, the large language model could take a prompt and use the prompt to identify keywords that correspond to a list of relevant objects. The keyword could be provided to a search API that identifies specific objects in the virtual environment corresponding to the search terms. An example of such relevant objects is provided as list 720 in FIG. 7A.

The prompt may include specific objects and specific descriptions or suggestions of how to locate the objects. Alternatively, the prompt may describe a type of scene, and the type of scene can be used to infer relevant objects and where to place them. For example, prompt 512 in FIG. 5 refers to placing an army in a defensive position. The system is able to identify relevant specific objects for placement corresponding to such a prompt. For example, list 720 shows that the specific available objects are a House, a Road, a Mountain, a Vehicle, and Convenience Store. Each of the available objects may be associated with dimensions, which can be considered when placing the objects. For example, using the dimensions can suggest proper locations and avoid overlap between objects. It is of note that in this example, the large language model infers from the prompt that only some of the possible objects are actually to be placed. Block 430 may be followed by block 440.

In block 440, the system determines spatial placement information for the object(s). For example, the prompt is further analyzed by the large language model. This further analysis involves considering individual placement operations produced by having the large language model associate a series of placement operations with a query. For example, a possible query would be to construct, “A medieval kingdom, with a sprawling castle at its center, surrounded by rolling hills, farms, and villages. The castle has high walls, a drawbridge, and a moat filled with alligators. Inside, there are grand halls, ornate tapestries, and gold-plated ceilings. Outside, there are knights jousting in a tournament field and commoners going about their daily business in the town square.”

After identifying a list of objects in block 430, the system takes the prompt and transforms it into at least one sub-task, where the sub-tasks can be used to determine spatial placement information. For example, there may be a series of sub-tasks, specified using natural language, that define part of performing the prompt. Each sub-task is completed by specific placement instructions that accomplish the sub-task. For example, part of the prompt is that there is “a moat filled with alligators.” This may lead to the natural language sub-task “Place a drawbridge across the moat, and fill the moat with alligators.” Such a natural sub-task could be implemented by specific placement tasks (specified using a scripting language or macros) that place a drawbridge and place the alligators, while considering relative placement information about a previously placed moat. Block 440 may be followed by block 450.

In block 450, the system places object(s) in the virtual experience based on the spatial placement information. As indicated in the description of block 440, the large language model determines the spatial placement information. The objects are placed accordingly, once the objects are placed, this placement updates the virtual experience accordingly. For example, such placement may user virtual experience updater 150. Hence, an updated view of the virtual experience may be provided to the user (such as at virtual experience application 112a, based on hosting by virtual experience engine 104).

FIG. 4 shows determining spatial placement information in block 440 and placing object(s) in a virtual experience in block 450 because placing objects in a virtual experience is a principal use case for various implementations. However, in some cases, once the object(s) are identified in block 430, block 440 may involve an object attribute to change, and block 450 may involve changing that attribute.

In block 450, the system may also use the large language model to determine if further objects are to be identified and/or placed from the current prompt. If so, the system identifies and places objects appropriately. Block 450 may be followed by block 460.

In block 460, the system determines if another prompt is to be received and processed. If so, the system returns to block 420, so that the system receives another user prompt. Such an approach allows the system to iterate prompting in a way that a virtual experience is constructed in stages. For example, FIGS. 2A-2D show iteratively designing a game by using four prompts, each of which adds features and functionality to a virtual experience. Thus, new prompts may be received any number of times for refining the generated virtual experience.

If it is determined in block 460 that no further prompts are to be received, the system has come to an end of the scene construction method. At this point, the virtual experience may be provided to a creator or to a user. A creator may choose to make any final changes to the virtual experience using standard tools, in case the conversational AI was unable to incorporate any desired features. Alternatively, the virtual experience may be provided to a user for the user to interact with, such as through virtual experience application 112a. Should further changes be necessary later, the process could begin again by supplying another one or more user prompts.

### Advantages, Benefits, and Metrics

The techniques described herein provide several advantages for creators or developers of virtual experiences. The interface can provide a single, central interface for defining a virtual experience. This interface allows a user to make a majority of changes using a simple, consistent approach. Also, use of the LLMs enables taking into account the context and history of build of the virtual experience, e.g., objects added initially and their placement, and subsequent refinements, based on user prompts. The history of user prompts and LLM responses additionally configure the LLM to interpret prompts in a coherent way over a session (or plurality of sessions) over which the virtual experience is generated or modified.

Additionally, because LLMs have a significant amount of background knowledge built-in, LLMs can provide suggestions about how to build scenes or successfully integrate game mechanics. Moreover, if the LLM has difficulty accomplishing a task, it may be able to provide documentation or instructions to a user to help the user use other tools to accomplish a goal.

These techniques will have other advantages. For example, the techniques may provide a framework for internal and external developers to integrate into a common system. There may also be a more consistent user interface (UI). Furthermore, it may be possible to gather and analyze query data to prioritize future extensions and experiments with respect to the system. Additionally, conversational AI may provide improved experiences. For example, in addition to placing a Non-Player Character (NPC) in a virtual experience, the conversational AI could help construct a conversational personality for the NPC.

Success of these techniques can be demonstrated based on certain criteria. For example, one goal would be that usage of conversational creation would increase efficiency of scene creation. Such efficiency could be demonstrated by sustained usage of the AI assistance features and by retention of created content (e.g., low deletion).

It may be possible to measure the success of adopting some of these techniques using certain metrics. For example, creator Daily Active User (DAU) counts may indicate how successful the techniques are. For example, both new and experienced users will likely use a system more if their experience is more satisfying and pleasant. The improved experience will also likely increase usage and user retention. These metrics should also demonstrate efficacy of improvements to the system.

### FIG. 5: Example Use Case Based on Identifying and Using Macros

FIG. 5 is an example 500 of how a user prompt is translated into a series of subtasks that create a scene using macros, in accordance with some implementations. For example, FIG. 5 shows a block of text 510 showing how a user prompt is transformed into sub-tasks and corresponding implementation macros. For example, the block 510 begins with a query 512 “An army exposed on all sides prepares a defensive position.”

The query 512 is processed using a large language model to produce an object list 514. While the object list 514 in the example of FIG. 5 does not list specific objects, the other portions of the block 510 indicates that the objects may include “Barbed wire,” “Sandbags,” “Trenches,” “Soldiers,” “Ammo crates,” and “Artillery cannon.” These objects may be placed in quantities and at locations as shown later in the block 510.

There is a label 516 marked “completion” that provides the sub-tasks necessary to create the scene. For example, the block 510 may include first task 520, second task 522, third task 524, fourth task 526, fifth task 528, sixth task 530, and seventh task 532. Each of these tasks is part of the construction of “a defensive position” for an “army” as mentioned in the query 512. Each task includes a natural language sentence explaining a portion of constructing the scene. The tasks are then followed by macros specifying exactly how to place the objects in the task. There may be several such macros. Macros can make systems more extensible and can improve quality because the LLM does not have to handle all the spatial computation.

For example, the macros may include the following example macros:
single_object(ObjectName, ObjectWidth, ObjectHeight, X start, Y start): Place an individual object with its lower left corner at (X,Y).
rand_rectangle_placement(ObjectName, ObjectWidth, ObjectHeight, X minimum, Y minimum, X max, Y max, n_objects): Randomly scatter n_objects with their lower left corner (X,Y) uniformly distributed inside the defined rectangular bounding box.
fill_placement(ObjectName, ObjectWidth, ObjectHeight, X minimum, Y minimum, X max, Y max): tiles objects through the designated bounding box (lower left corners).

The above macros are examples of procedures that take a set of parameters and use the parameters to determine an appropriate way to arrange objects. These examples are fairly specific in terms of the effects they have on the objects arranged based on the corresponding macros. However, there may also be macros used to describe a higher level explanation of the scene. More generally, there may be a system that outputs a higher level of abstraction for the scene rather than final positions and uses macros to do so. In general, macros are interchangeable with functions in that macros define a series of steps that, when performed, accomplish a given objective.

There may be certain rules or caveats that control of objects are placed for the placement to be considered proper. For example, placement may place large structures first, followed by smaller objects. Rand_rectangle_placement may be reserved for scattering small objects, and may be inappropriate for large objects. In general, it is important to always avoid overlap, as this will result in a corrupt virtual experience because a virtual experience cannot operate correctly with overlapping objects.

First task 520 corresponds to “Park tanks in a cluster at the center of camp.” First task 520 also includes instruction 1, specifying parameters of a macro to place the tanks. The macro places tanks in a reasonable cluster.

Second task 522 corresponds to “Next, placed barbed wire around the perimeter of the camp.” Second task 522 also includes instructions 2-5, specifying parameters of macros to place the barbed wire. The macros place barbed wire segments appropriately, surrounding the camp.

Third task 524 corresponds to “Next, placed sandbags around two sides of the camp.” Third task 524 also includes instructions 6-7, specifying parameters of macros to place the sandbags. The macros place groups of sandbags appropriately, surrounding sides of the camp.

Fourth task 526 corresponds to “Place trenches on the other two sides.” Fourth task 526 also includes instructions 8-9, specifying parameters of macros to place the trenches. The macros place trenches appropriately, surrounding other sides of the camp.

Fifth task 528 corresponds to “Scatter soldiers inside the trenches.” Fifth task 528 also includes instructions 10-11, specifying parameters of macros to place the soldiers. The macros place groups of soldiers appropriately, placing them relative to the trenches.

Sixth task 530 corresponds to “Scatter ammo crates behind the trenches for the soldiers to access.” Sixth task 530 also includes instructions 12-13, specifying parameters of macros to place the ammo crates. The macros place groups of ammo crates appropriately, based on the placement of the trenches and the soldiers.

Seventh task 532 corresponds to “Place a few artillery cannons in the area behind the sandbags.” Seventh task 532 also includes instructions 14-16, specifying parameters of a macro to place the artillery cannons. The macros place individual artillery cannons appropriately, based on the placed sandbags.

Below seventh task 532, the block 510 shows an ellipsis “ . . . ” indicating that there may be more tasks than these example tasks when creating the scene.

Hence, the LLM can provide a chain of thought reasoning as an effective way to build the scene. This approach progressively creates a scene corresponding to one or more prompts, and how successive prompts depend on prior prompts.

The LLM may be provided with even more sophisticated high-level macros. Advanced macros could allow approaches to scale up significantly beyond context length, handle overlaps, object interactions, etc. Such macros could include:
Scatter (list of items, distribution (random, grid, tile, etc.), area to cover): Fill an area with an item.
Adjacency: Put object X in front of object Y (model provides rough coordinates and this macro figures out the exact placement. Adjacency may resemble Computer-Aided Design (CAD) constraints (e.g., this object should have contact with this other object.)
Surround: Surround X with Y.

LLM training includes a corpus on the set of human-written documents on military strategy on which it performs reasoning. Accordingly, the token prediction login of the LLM allows the LLM to distinguish defensive and offensive positions through text, photography, drawings, etc. that it has previously been trained on. The LLM has reasoning capacity to infer, for example, to put barbed wire around edges of a camp based on the prompt 512.

Placement does not use general heuristics, though they may be included in the prompt. The LLM defers to what is explicitly recited in the prompt. For example, if the prompt says a barbed wire at the center of a defensive position, then the LLM would override its default reasoning and attempt to create something coherent that honors what is specified in the prompt.

When interpreting the prompt, the LLM may also generate clarification questions. Such clarification questions may allow the LLM to take an instruction that appears either inconsistent or ambiguous and obtain clarification that allows the LLM to identify and place objects. For example, assume that the initial prompt is “generate a football field in the ocean.” Ordinarily, the ocean is not an appropriate place for a football field (this problem would not be an issue for a “battleship”).

Hence, the LLM can ask, “Do you want an island with a football field or a football field on a large ship?” and the user can provide input that resolves the confusion. LLMs are good at these tasks and can automatically seek such user guidance. Another example is if no matching objects are found, the LLM could ask for clarification. The LLM may also be designed to detect and intervene if the prompt is violative of trust and/or safety. For example, the prompt may be analyzed to maintain trust and/or safety for inappropriate words, phrases, or references. There may be a dictionary of inappropriate content, or the LLM may have built-in knowledge of what is inappropriate.

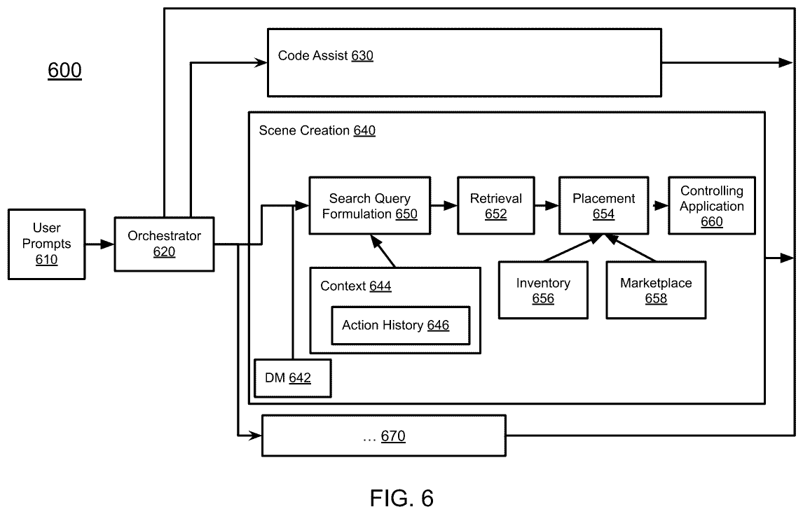

### FIG. 6: Structure of Data Flow for Using Prompt to Create Scene

FIG. 6 is a diagram 600 of how a user prompt is processed to create a scene, in accordance with some implementations. The processing begins with the receipt of user prompt(s) 610. Such user prompt(s) 610 are provided to an orchestrator 620. The orchestrator 620 provides the user prompt(s) 610 to a code assist module 630, to a scene creation module 640, and to a demand modeling (DM) module 642. The role of the orchestrator 620 is to coordinate the use of internal resources to take the user prompt(s) 610 and other sources of knowledge to automatically create a virtual experience, with the help of a large language model. The orchestrator 620 also interacts with a module 670 that helps coordinate feedback between the scene creation module 640 and the orchestrator 620.

The code assist module 630 performs a code generation task. Based on the given prompt and inserted objects, the code assist module 630 decides upon appropriate features and generates code for obtaining the desired behavior. Such code can be used to explicitly instruct the virtual environment how to implement an appropriate virtual experience.

The scene creation module 640 receives a number of inputs and processes them to create and/or modify instructions to specify the virtual experience. For example, the scene creation module 640 may include a first operation of search query formulation 650. The search query formulation 650 may receive information about the user prompt(s) 610 from the orchestrator 620.

The search query formulation 650 may also receive information from demand modeling (DM) module 642 and context module 644. Demand modeling module 642 may include metadata that indicates user preferences, which may be helpful in identifying the right objects. The context module 644 may include an action history module 646. For example, the context module 644 may include scene attributes that guide which objects are relevant and which properties objects have that should be considered. Action history module 646 may specify traits of previously defined objects. Such traits may be helpful when identifying and placing new objects.

When performing search query formulation 650, all of this information is automatically provided to and considered by the LLM. The LLM is able to consider the user prompt(s) 610. The prompt(s) 610 suggest a scene that is to be constructed. The scene construction involves identifying object(s) to place in the user experience according to performing a query.

The query includes keywords suggested by considering the prompt. As noted, the search query formulation 650 may take into account context 644, specifically action history 646. For example, context module 644 may provide information about object placement in a specific environment. Action history module 646 provides a particular type of context 644. Action history module 646 may provide the LLM with the ability to consider previous parts of the prompt analysis when creating the search query. For example, objects may be placed relative to other objects, or previous object placement may suggest where to place new objects. With user permission, a history of user prompts may be stored, providing information that is useful as discussed in some implementations.

After search query formulation 650 occurs, retrieval 652 uses the corresponding keywords in the search query to identify objects for placement 654. For example, the retrieval 652 may return a list of the best matches (e.g., 3, 5, 10, or more matches) for each keyword (though additional numbers of matches may be used in other implementations). Some keywords may be searched together as phrases, and some matches may appear multiple times. Various implementations may also use various metadata related to objects. In some implementations, the retrieval 652 uses search engine 146 as shown in FIG. 1B.

Placement 654 pulls the objects in the virtual environment from at least one source. For example, the objects may be pulled from a user's online inventory 656 or from an online marketplace 658. For example, the placement 654 receives the list of retrieved online objects to place. The objects may be associated with corresponding dimensions (such as length and width). The objects may also be associated with metadata that informs how the objects are to be placed, based on properties of the objects (for example, barbed wire will often be placed to surround a region).

Based on knowledge the LLM associates with the user prompt(s) 610, the LLM in the placement 654 determines how many instances of the objects to place and how to place them. This placement 654 results in controlling developer application 660 appropriately. Here, developer application 660 refers to an example part of a virtual environment that is designed to provide capabilities for constructing virtual experiences in the virtual environment. For example, controlling developer application 660 may involve breaking user prompt(s) into natural language sub-tasks. The sub-tasks may be accomplished by associating the sub-tasks with defined commands provided in a structured format such as macros or commands in a defined language, in accordance with the example of FIG. 5.

Alternatively, the controlling developer application 660 may include instead individually placing objects one at a time, based on dimensions and coordinates. The placed objects are associated with bounding boxes. The placement should include a detection operation that establishes whether any of the placed objects would overlap and correct the situation if potential overlap would occur.

There may be various goals to achieve during placement 654. For example, these goals may include placing objects accurately on the terrain, placing objects more accurately in patterns, placing objects in a specific area (such as a defined square), and revising objects currently in a virtual experience. The placement 654 may also be based on different attributes like item cost, size, or style. Objects could be filtered based on attributes, total cost could be limited, and so on.

Placement 654 may be at a relatively high level, such as bounding-box level. For finer or more sophisticated placement, a system would use a different module that considers alignment. For example, “put this pillow on this couch” would need to consider the relative placement of the pillow with respect to the couch for proper placement. For example, an object could be placed inside another, adjacent to another, or to surround another. Alignment could also consider orientation or other aspects of object placement.

Placement of objects may have certain levels of difficulty. For example, a simple instruction may place one object. Such an instruction identifies an object using a basic semantic search and inserts the object where the camera is looking. A slightly more complicated instruction may insert multiple objects in a simple pattern. For example, such an instruction could place 10 houses in a row, or in a two by five grid.

Alternatively, a prompt could request an alpine forest, and could lead to a random placement of trees in an area. An even more complicated prompt could request a network of streets or surrounding a house with trees, which would involve considering relative positions of objects. A still more complicated prompt could create a terrain and create a “village” which would have multiple types of buildings. Another prompt could be complicated by requesting an object (such as a “rustic cottage”) be created out of component objects (such as “wood” and “bricks”).

There may also be various levels of scene understanding used to construct the virtual experience. For example, placement understanding could identify a type of object, the object's ID, coordinates for the object (including location and dimensions), and orientation. Visual understandings of the objects could include descriptive properties (a “rustic” house) or the object being composed of other objects or materials (a “house” made of “wood” and “bricks”).

There may also be a capability to understand terrain (water, mountain, etc.) and how the nature of the terrain could affect placing objects on such terrain. There may also be a capability to understand inner parts of objects. For example, a car may include four seats and it may be possible to consider these seats as individual objects as well as fixed portions of the car.

As noted, there is also a preference for a domain-specific language for describing a scene. The language is designed to both understand the current state of the scene and to describe how to modify the scene. For example, a scene may include a list of objects, where each entry in the list names the object, its dimensions, and positions. Modifications may be specified as instructions to place individual objects, or as macros.

The language could also include other instructions or macros that specify other commands, such as changing properties of existing objects. The language should be concise yet descriptive, focus on describing the virtual experience presented in the view-port, and be able to understand and describe style. In addition to a text-based language, it is also possible to use multimodal input, such as by providing an image that indicates what the user wants to create.

It is also possible to have an LLM do another pass before presenting the scene to the user. This pass can cause another cycle of generation with the feedback that the LLM gives. This evaluation operation can also be done programmatically when there are functions for checking conditions like overlapping objects and these conditions can be flagged to be fixed (either automatically or through user interaction). The checks can also look for game related properties (e.g., is a map traversable, does the scene make sense based on defined game conditions) and check for inappropriate or unsafe content.

For example to avoid overlap, an initial candidate placement is obtained from the LLM. Then, non-LLM techniques determine that there is overlap. For example, the objects in the initial candidate placement are processed to detect overlap, and where overlap occurs. If the techniques detect overlap, the LLM is prompted again with instructions such as “modify it to remove overlap between object A and B; other objects to stay in place.” Alternatively, the LLM may be prompted to generate new placement entirely, depending on whether “modify” or “generate” is happening, and based on additional user input, if available.

### FIGS. 7A-7B: Diagram of Use Case of Using Large Language Model to Interpret Prompt to Place Objects in Virtual Experience

FIG. 7A is a diagram 700A of providing an example initialization prompt and an example instruction prompt to a large language model to determine available objects, in accordance with some implementations. Box 710 presents a natural language initialization instruction for the large language model. The instruction specifies that the LLM is to respond to a prompt by placing boxes on a 2D map to create a scene, explaining reasoning as the response proceeds. The instructions also specify that the LLM will receive objects in a particular format and will be placed as “<Object #>: <Object Type>, <X, Y>. The instructions also specify that the placement is to avoid overlapping objects.

The boxed instructions 710 perform an initializing 712 of the large language model 714. Then, the large language model 714 receives a prompt 716. Here, prompt 716 is “Generate streets on both sides of two houses, stretching towards a mountain in the distance.” The prompt 716 is fed into a large language model 714 as an interpretation 718 operation. The large language model 714 then produces identified objects 722. Identified objects 722 correspond to the list of available objects 720. The list of available objects includes a “House,” a “Road,” a “Mountain,” a “Vehicle”, and a “Convenience Store,” as well as dimensions for each of these objects.

FIG. 7B is a diagram 700B of providing the example instruction prompt and the available objects to a large language model along with examples of a good answer and a bad answer, in accordance with some implementations. In FIG. 7B, the diagram shows that FIG. 7B begins with a prompt 722 and a list of available objects. For example, prompt 722 may correspond to the example prompt 716 shown in FIG. 7A and available objects 724 may correspond to the list 720 shown in FIG. 7A. Prompt 722 and available objects 724 are provided as inputs into the large language model 726. The large language model 726 yields two example answers. Answer 728 is considered to be a good answer and answer 730 is considered to be a bad answer.

For example, answer 728 places two houses, places a street between the houses, puts streets on the outside of each house, and puts a mountain at the end of the street. This answer 728 is a reasonable interpretation of the prompt. All of the objects mentioned in the prompt are present in answer 728. Furthermore, answer 728 does not place any objects in a way that would result as overlap. It may be noted that answer 728 does not use all of the available objects, in that the prompt does not suggest the placement of any “Vehicle” or “Convenience Store” objects.

Answer 730 is a bad answer. As in answer 728, the answer 730 places two houses opposite each other. Answer 730 then also attempts to put a street between the houses. However, this results in a place of the road that would result in overlap with one of the houses. Such an overlap is detected and prevented. Hence, the system rejects answer 730 and tries again to place the objects in a good answer (as in answer 728).

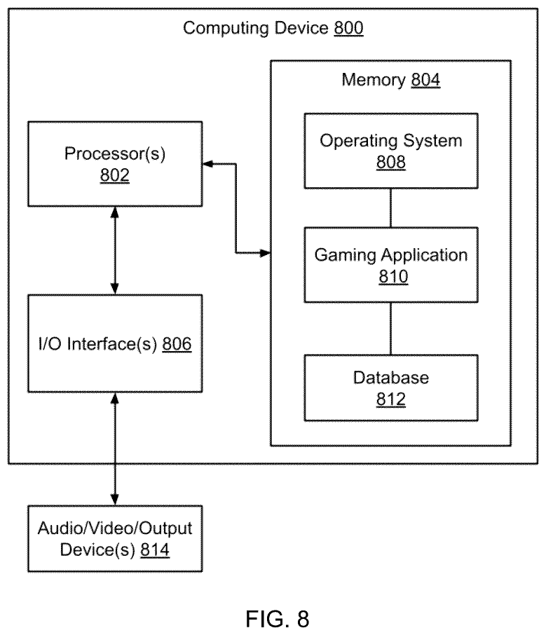

### FIG. 8: Computing Device

FIG. 8 is a block diagram of an example computing device 800 which may be used to implement one or more features described herein. In one example, device 800 may be used to implement a computer device (e.g. 102 and/or 110 and/or 130 of FIG. 1A), and perform appropriate method implementations described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 800 includes a processor 802, a memory 804, input/output (I/O) interface 806, and audio/video input/output devices 814.

Processor 802 can be one or more processors and/or processing circuits to execute program code and control basic operations of the device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in device 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the server device 800 by the processor 802, including an operating system 808, one or more applications 810, e.g., a database 812. In some implementations, application 810 can include instructions that enable processor 802 to perform the functions (or control the functions of) described herein, e.g., some or all of the methods described with respect to FIG. 4.

For example, applications 810 can include a database 812, which as described herein can provide data management and storage within an online virtual experience server (e.g., 102). Elements of software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the server device 800 with other systems and devices. For example, network communication devices, storage devices (e.g., memory and/or data store 120), and input/output devices can communicate via interface 806. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 814 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 8 shows one block for each of processor 802, memory 804, I/O interface 806, and software blocks of operating system 808 and virtual experience application 810. These blocks may represent one or more processors or processing circuitries, operating systems, memories, I/O interfaces, applications, and/or software engines. In other implementations, device 800 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 800, e.g., processor(s) 802, memory 804, and I/O interface 806. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 814, for example, can be connected to (or included in) the device 800 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 600) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

We claim:

1. A computer-implemented method, the method comprising:
receiving a user prompt, the user prompt comprising text criteria specifying for generation or modification of a virtual experience, wherein the user prompt is a natural language prompt that includes at least one of text data, audio data, or video data;
identifying one or more objects in the virtual experience having one or more attributes that correspond to the text criteria, the one or more objects being identified by a large language model;
determining spatial placement information in the virtual experience for the one or more objects by using the large language model to interpret the text criteria to determine locations for the one or more objects in the virtual experience; and
placing the one or more objects in the virtual experience based on the spatial placement information.

2. The computer-implemented method of claim 1, further comprising modifying the virtual experience by changing an attribute of a specified object of the one or more objects in the virtual experience based on the text criteria, wherein the attribute comprises an appearance, a behavior, a position, an orientation, a style, a material, a texture, a cost, a property, or another modifiable aspect of the specified object.

3. The computer-implemented method of claim 1, wherein the identifying of the one or more objects in the virtual experience comprises:
generating one or more keywords using the large language model; and
performing a keyword search based on the keywords.

4. The computer-implemented method of claim 1, wherein the placing comprises placing objects such that there is no overlap.

5. The computer-implemented method of claim 1, wherein the user prompt comprises an updated prompt.

6. The computer-implemented method of claim 1, further comprising providing, to a user, at least one of a view of the virtual experience including the one or more objects as placed or a summary of changes made to the virtual experience.

7. The computer-implemented method of claim 1, wherein the large language model uses at least one of scene context and a history of user prompts to perform at least one of identifying the one or more objects or determining the spatial placement information.

8. The computer-implemented method of claim 1, wherein the large language model uses at least one macro obtained from the natural language prompt to perform at least one of identifying the one or more objects or determining the spatial placement information.

9. A non-transitory computer-readable medium comprising instructions that, responsive to execution by a processing device, causes the processing device to perform operations comprising:
receiving a user prompt, the user prompt comprising text criteria specifying for generation or modification of a virtual experience, wherein the user prompt is a natural language prompt that includes at least one of text data, audio data, or video data;
identifying one or more objects in the virtual experience having one or more attributes that correspond to the text criteria, the one or more objects being identified by a large language model;
determining spatial placement information in the virtual experience for the one or more objects by using the large language model to interpret the text criteria to determine locations for the one or more objects in the virtual experience; and
placing the one or more objects in the virtual experience based on the spatial placement information.

10. The non-transitory computer-readable medium of claim 9, the operations further comprising modifying the virtual experience by changing an attribute of a specified object of the one or more objects in the virtual experience based on the text criteria, wherein the attribute comprises an appearance, a behavior, a position, an orientation, a style, a material, a texture, a cost, a property, or another modifiable aspect of the specified object.

11. The non-transitory computer-readable medium of claim 9, wherein the identifying of the one or more objects in the virtual experience comprises:
generating one or more keywords using the large language model; and
performing a keyword search based on the keywords.

12. The non-transitory computer-readable medium of claim 9, wherein the placing comprises placing objects such that there is no overlap.

13. The non-transitory computer-readable medium of claim 9, wherein the large language model uses at least one macro obtained from the natural language prompt to perform at least one of identifying the one or more objects or determining the spatial placement information.

14. The non-transitory computer-readable medium of claim 9, the operations further comprising providing, to a user, at least one of a view of the virtual experience including the one or more objects as placed or a summary of changes made to the virtual experience.

15. The non-transitory computer-readable medium of claim 9, wherein the large language model uses at least one of scene context and a history of user prompts to perform at least one of identifying the one or more objects or determining the spatial placement information.

16. A system comprising:
a memory with instructions stored thereon; and
a processing device, coupled to the memory, the processing device configured to access the memory and execute the instructions, wherein the instructions cause the processing device to perform operations including:
receiving a user prompt, the user prompt comprising text criteria specifying for generation or modification of a virtual experience, wherein the user prompt is a natural language prompt that includes at least one of text data, audio data, or video data;
identifying one or more objects in the virtual experience having one or more attributes that correspond to the text criteria, the one or more objects being identified by a large language model;
determining spatial placement information in the virtual experience for the one or more objects by using the large language model to interpret the text criteria to determine locations for the one or more objects in the virtual experience; and
placing the one or more objects in the virtual experience based on the spatial placement information.

17. The system of claim 16, wherein the large language model uses at least one macro obtained from the natural language prompt to perform at least one of identifying the one or more objects or determining the spatial placement information.

18. The system of claim 16, wherein the identifying of the one or more objects in the virtual experience comprises:
generating one or more keywords using the large language model; and
performing a keyword search based on the keywords.

19. The system of claim 16, wherein the placing comprises placing objects such that there is no overlap.

20. The system of claim 16, the operations further comprising providing, to a user, at least one of a view of the virtual experience including the one or more objects as placed or a summary of changes made to the virtual experience.
